(19) United States
(12) Patent Application Publication
(10) Pub. No.: US 2026/0088565 A1
(43) Pub. Date: Mar. 26, 2026

(54) HIGH VOLTAGE POWER CONNECTOR SYSTEM

(71) Applicant: FCI USA LLC, Etters, PA (US)

(72) Inventors: Mithun Hormese Paul, Cochin (IN); Vipin Manangath Gopi, Cochin (IN); Jose Thomas, Cochin (IN); Christopher S. Gieski, Dillsburg, PA (US)

(73) Assignee: FCI USA LLC, Etters, PA (US)

(21) Appl. No.: 19/408,687

(22) Filed: Dec. 4, 2025

(30) Foreign Application Priority Data
Aug. 5, 2025 (IN) 202511074350

(51) Int. Cl. H01R 13/629; H01R 13/44; H01R 24/28

(52) U.S. Cl. CPC H01R 13/62938; H01R 13/44; H01R 24/28

(57) ABSTRACT

A plug connector includes a housing having recesses arranged in rows, plug contacts within the recesses, and securing structures configured to attach the plug connector to a receptacle connector. A receptacle connector includes a housing having tubular protrusions, the tubular protrusions having receptacle contacts at inner sides of the tubular protrusions, the tubular protrusions extending along a plugging and unplugging direction of the receptacle connector, wherein the tubular protrusions are arranged in rows; and securing structures configured to attach the receptacle connector to a plug connector. The securing structures may be rotating latches operated by rotation towards or away from a housing or over mold. The over mold may act as a gripping surface. Cable assemblies include the plug connector or the receptacle connector.

### CROSS-REFERENCE TO RELATED APPLICATIONS

This application claims priority to and the benefit of Indian Patent Application No. 202511074350 filed Aug. 5, 2025, titled “HIGH VOLTAGE POWER CONNECTOR SYSTEM,” the contents of which is hereby incorporated herein by reference in its entirety.

### FIELD

The present disclosure relates generally to the technical field of electrical connectors and particularly to electrical connectors for power cables.

### BACKGROUND

Electrical connectors are used to connect two or more electronic devices together to provide a reliable electrical connection. In a data center, electrical connectors connect electronic components and supply electrical power.

### SUMMARY

In some aspects, the techniques described herein relate to a plug connector, including: a housing having recesses, wherein the recesses are arranged in rows; plug contacts within the recesses; and securing structures configured to attach the plug connector to a receptacle connector.

In some aspects, the techniques described herein relate to a plug connector, wherein the recesses are arranged in exactly two rows.

In some aspects, the techniques described herein relate to a plug connector, wherein the recesses are arranged in a 2×2 array.

In some aspects, the techniques described herein relate to a plug connector, wherein the securing structures include pins configured to engage with slots of a rotating latch of a receptacle connector.

In some aspects, the techniques described herein relate to a plug connector, wherein the securing structures include four pins configured to engage with rotating latches of a receptacle connector.

In some aspects, the techniques described herein relate to a plug connector, wherein the securing structures are configured to engage with a plurality of rotating latches of a receptacle connector.

In some aspects, the techniques described herein relate to a plug connector, wherein: the housing includes two opposing sides and a mating face therebetween; the recesses are exposed at the mating face; the securing structures include two securing structures on each of the two opposing sides; and the securing structures are symmetrically disposed about two perpendicular centerlines of the mating face.

In some aspects, the techniques described herein relate to a plug connector, wherein the securing structures include exposed ends of pins inserted into the housing.

In some aspects, the techniques described herein relate to a plug connector, wherein the pins each include a neck and a head extending from the housing.

In some aspects, the techniques described herein relate to a plug connector, wherein the pins include knurled portions inserted into the housing.

In some aspects, the techniques described herein relate to a plug connector, wherein the recesses have polarizing slots on at least some inner surfaces of the recesses, the polarizing slots extending in a plugging and unplugging direction of the plug connector.

In some aspects, the techniques described herein relate to a plug connector, wherein the polarizing slots are on sides of the at least some inner surfaces of the recesses facing a side of the housing having at least one of the securing structures.

In some aspects, the techniques described herein relate to a plug connector, wherein all of the polarizing slots are on a same side of the recesses.

In some aspects, the techniques described herein relate to a plug connector, further including insulating caps attached to distal ends of the plug contacts.

In some aspects, the techniques described herein relate to a plug connector, wherein the plug contacts have an external cross-section that is circular.

In some aspects, the techniques described herein relate to a plug connector, wherein the housing is configured to be attached to a plurality of cables.

In some aspects, the techniques described herein relate to a receptacle connector, including: a housing having tubular protrusions, the tubular protrusions having receptacle contacts at inner sides of the tubular protrusions, the tubular protrusions extending along a plugging and unplugging direction of the receptacle connector, wherein the tubular protrusions are arranged in rows; and securing structures configured to attach the receptacle connector to a plug connector.

In some aspects, the techniques described herein relate to a receptacle connector, wherein the tubular protrusions are arranged in exactly two rows.

In some aspects, the techniques described herein relate to a receptacle connector, wherein the tubular protrusions are arranged in a 2×2 array.

In some aspects, the techniques described herein relate to a receptacle connector, wherein an outer diameter of the receptacle contacts is between 17 mm and 22 mm.

In some aspects, the techniques described herein relate to a receptacle connector, wherein the securing structures includes rotating latches.

In some aspects, the techniques described herein relate to a receptacle connector, wherein the securing structures includes a first rotating latch on a first side of the housing and a second rotating latch on a second side of the housing opposite the first side.

In some aspects, the techniques described herein relate to a receptacle connector, further including an over mold attached to the housing.

In some aspects, the techniques described herein relate to a receptacle connector, wherein, when the over mold acts as a gripping surface.

In some aspects, the techniques described herein relate to a receptacle connector, wherein the first and second rotating latches have respective slots configured such that when the first and second rotating latches are in an open position rotated away from the over mold the slots are positioned to receive respective pins of a mating connector.

In some aspects, the techniques described herein relate to a receptacle connector, wherein the slots are configured such that closing the first and second rotating latches by rotating the first and second rotating latches toward the over mold pulls the receptacle connector towards a mating connector.

In some aspects, the techniques described herein relate to a receptacle connector, wherein the rotating latches include a metal.

In some aspects, the techniques described herein relate to a receptacle connector, wherein the metal is covered with an insulating material.

In some aspects, the techniques described herein relate to a receptacle connector, wherein the tubular protrusions have polarizing projections on at least some outer surfaces of the tubular protrusions, the polarizing projections extending in a plugging and unplugging direction of the plug connector.

In some aspects, the techniques described herein relate to a receptacle connector, wherein the polarizing projections are on sides of the at least some outer surfaces of the tubular protrusions facing a side of the housing having at which the securing structures are attached to the housing.

In some aspects, the techniques described herein relate to a receptacle connector, wherein all of the polarizing projections are on a same side of the tubular protrusions.

In some aspects, the techniques described herein relate to a receptacle connector, further including contact retention rings between distal ends of the tubular protrusions and the receptacle contacts.

In some aspects, the techniques described herein relate to a cable assembly, including: a plug connector, including: a housing having recesses, wherein the recesses are arranged in rows; plug contacts within the recesses; and securing structures configured to attach the plug connector to a receptacle connector; and a plurality of cables having conductors electrically coupled to the plug contacts.

In some aspects, the techniques described herein relate to a cable assembly, wherein the securing structures are configured to engage with a plurality of rotating latches of a receptacle connector.

In some aspects, the techniques described herein relate to a cable assembly, wherein: the housing includes two opposing sides and a mating face therebetween; the recesses are exposed at the mating face; the securing structures include two securing structures on each of the two opposing sides; and the securing structures are symmetrically disposed about two perpendicular centerlines of the mating face.

In some aspects, the techniques described herein relate to a cable assembly, wherein the securing structures include exposed ends of pins inserted into the housing.

In some aspects, the techniques described herein relate to a cable assembly, wherein the pins each include a neck and a head extending from the housing.

In some aspects, the techniques described herein relate to a cable assembly, wherein the pins include knurled portions inserted into the housing.

In some aspects, the techniques described herein relate to a cable assembly, including: a receptacle connector, including: a housing having tubular protrusions, the tubular protrusions having receptacle contacts at inner sides of the tubular protrusions, the tubular protrusions extending along a plugging and unplugging direction of the receptacle connector, wherein the tubular protrusions are arranged in rows; and securing structures configured to attach the receptacle connector to a plug connector; and a cable bundle having conductors electrically coupled to the receptacle contacts.

In some aspects, the techniques described herein relate to a cable assembly, wherein the securing structures includes rotating latches.

In some aspects, the techniques described herein relate to a cable assembly, wherein the securing structures includes a first rotating latch on a first side of the housing and a second rotating latch on a second side of the housing opposite the first side.

In some aspects, the techniques described herein relate to a cable assembly, further including an over mold attached to the housing.

In some aspects, the techniques described herein relate to a cable assembly, wherein, when the over mold acts as a gripping surface.

In some aspects, the techniques described herein relate to a cable assembly, wherein the first and second rotating latches have respective slots configured such that when the first and second latches are in an open position rotated away from the over mold the slots are positioned to receive respective pins of a mating connector.

In some aspects, the techniques described herein relate to a cable assembly, wherein the slots are configured such that closing the first and second latches by rotating the first and second latches toward the over mold pulls the receptacle connector towards a mating connector.

### BRIEF DESCRIPTION OF DRAWINGS

In the drawings, each identical or nearly identical component that is illustrated in various figures may be represented by a like numeral. For purposes of clarity, not every component may be labeled in every drawing. In the drawings:

FIG. 1A shows a perspective view of an exemplary plug connector, according to some embodiments.

FIG. 1B shows an exploded view of the plug connector of FIG. 1A.

FIG. 1C shows a cutaway view of the inside of the recess of the housing of the plug connector of FIG. 1A.

FIG. 1D shows a perspective view of a plug contact of the plug connector of FIG. 1A.

FIGS. 1E and 1F show front and perspective views of an insulating cap of the plug connector of FIG. 1A, respectively.

FIG. 2A shows a perspective view of an exemplary receptacle connector, according to some embodiments.

FIG. 2B shows a front view of the receptacle connector of FIG. 2A.

FIG. 2C shows a cutaway view of the inside of the plug connector of FIG. 2A.

FIG. 2D shows an exploded view of the receptacle connector of FIG. 2A.

FIG. 2E shows a side view of a rotating latch engaging with a pin of a mating connector.

FIG. 3 is a perspective view of an exemplary fastener that may be used to rotatably mount a securing structure to a connector housing in some embodiments of a connector.

### DETAILED DESCRIPTION

Described herein are new designs for electrical connectors that support high voltage separable interfaces, such as may be used to connect AC power sources to power shelves within a data center. Alternatively or additionally, these designs may support high current contacts.

As industry demands for computational power for artificial intelligence and other applications continue to increase, there is a demand for higher power levels to be provided to computing resources in data centers. Higher power levels can be provided by increasing the current and/or the voltage supplied. The inventors have recognized and appreciated that there is a need for connectors and cables to provide significant electric current in data centers, such as 100 A-300 A or greater. For example, cables and connectors may supply alternating current from an alternating current supply to a data center rack. In some data centers, AC/DC conversion may be performed at the data center rack (or another location) to convert alternating current into direct current. Cables and connectors are then used to provide the direct current to the computing modules (e.g., through a busbar or another conductor). The cables and connectors described herein may be used in particular for providing alternating current, although the present application is not limited in this respect, as in other applications the cables and connectors as described herein may be used to provide direct current.

The inventors have recognized and appreciated the challenges that can arise in space-constrained applications such as data centers, in which there is limited room available for accessing, mating and unmating cable assemblies and connectors. The connectors and cable assemblies described herein include features that facilitate mating and unmating the connectors. In particular, described herein is a dual-latch configuration that pulls mating connectors together during mating. Additionally, the inventors have recognized that cable assemblies capable of carrying high power may be heavy. The dual-latch configuration provides a robust mechanical connection that is resistant to forces that may pull the mated connectors apart (e.g., in the case of mated connectors being dropped onto a hard surface). Also described herein is an over mold that may act as a handle to grasp the cable assembly for mating and unmating. The over mold also allows the cable exit path from the connector to be in any desired direction. Advantageously, the cable exit direction for a connector may be changed for a connector by changing the over mold.

The design techniques as described herein may be used separately or together in any combination to provide any one or more of these benefits.

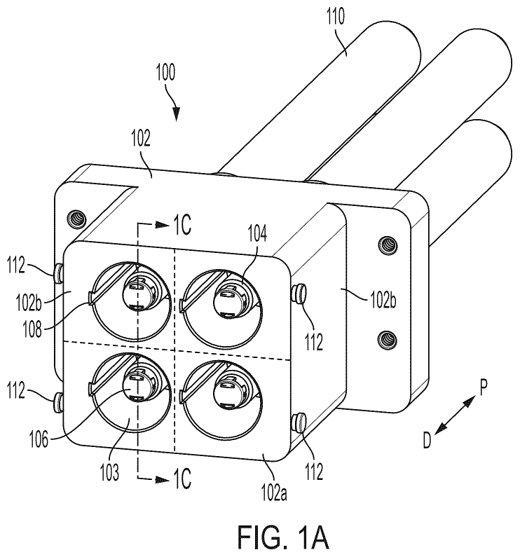

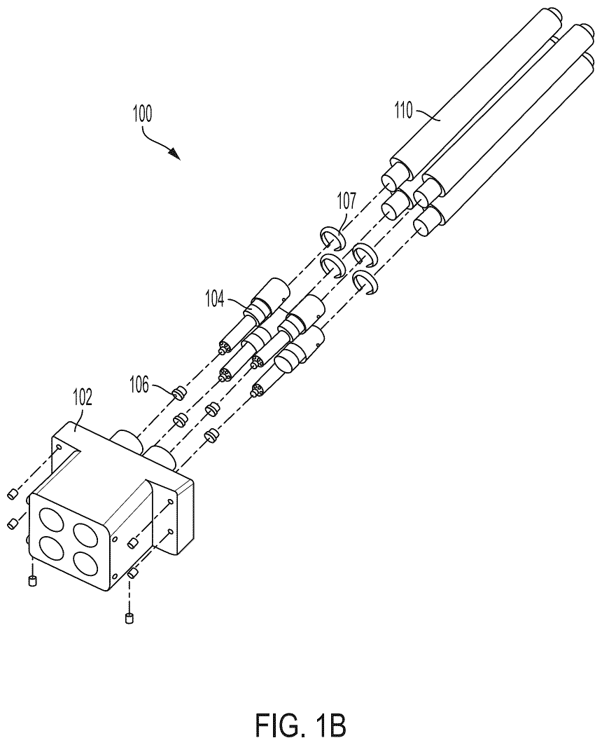

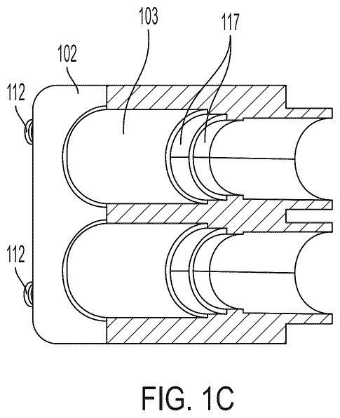

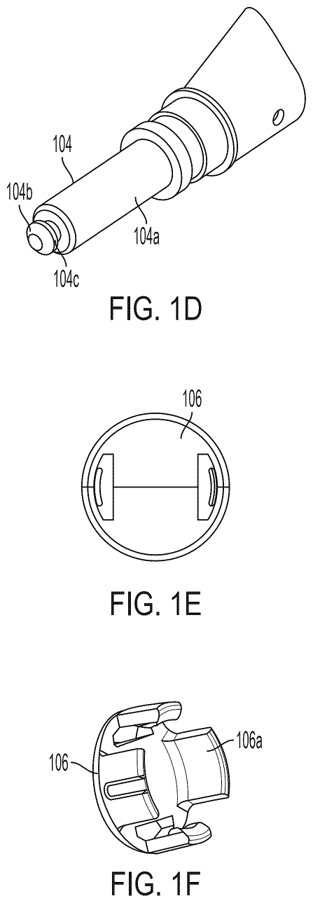

FIG. 1A shows an example of a plug connector 100, according to some embodiments. Plug connector 100 and cables 110, which protrude from the back side of plug connector 100, collectively form a cable assembly. The plugging and unplugging direction is illustrated with a two-headed arrow, with the proximal direction P away from the mating direction and distal direction D toward the mating direction labeled. Plug connector 100 has a housing 102 with a mating face 102a at the distal side and two opposing side faces 102b perpendicular to the mating face 102a. The plug connector 100 has a plurality of recesses 103 at the mating face 102a.

In this example, the housing 102 has four recesses 103 at the mating face 102a of the housing 102 arranged in a 2 by 2 array of two rows and two columns. However, this is an example, and a plug connector may have any number of recesses and contacts, such as fewer than four (e.g., two or three), or more than four (e.g., five, six, seven, eight or more). Within each recess 103 is disposed a plug contact 104 for making physical and electrical contact with the contact of a receptacle connector when the plug connector 100 is mated to the receptacle connector. The recesses 103 may have a generally cylindrical shape. The plug contacts 104 may be protrusions having an annular or cylindrical cross-section. The plug contacts 104 may have any suitable diameter at the locations where the plug contacts 104 contact the receptacle contacts, and some may have an outer diameter at such a location of 8-12 mm, such as 10 mm, for example, which may allow the plug connector 100 to carry significant current (e.g., 200 A-300 A, or more) with low series resistance. Within each recess 103, the plug connector 100 has a space with an annular cross-section between the plug contact 104 and the wall of the recess 103. The space accommodates a portion of a complementary receptacle connector when the plug connector 100 is mated with the receptacle connector.

In some embodiments, an insulating cap 106 is positioned at the tip of each plug contact 104 to prevent or reduce the likelihood of unwanted contact (e.g., by a human) with the plug contact 104, thereby improving safety. An insulating cap 106 may block an object inserted into a recess 103 from touching the plug contact 104. The insulating cap 106 may be attached to the distal end of each plug contact 104. Accordingly, the plug connector 100 may be a touch proof connector that is touch proof when unmated.

The recesses 103 may include one or more polarizing features, such as polarizing slots or projections. In this example, the recesses 103 include polarizing slots 108 designed to accommodate corresponding polarizing projections on complementary portions of the housing of a receptacle connector. As illustrated, the polarizing slots 108 may be recessed into a side of the recess 103, and may extend along a plugging and unplugging direction. When the plug connector 100 is mated with a receptacle connector, corresponding polarizing projections of the receptacle connector may extend into the polarizing slots 108, allowing only mating of connectors appropriately oriented and having complementary polarizing features. In some embodiments, and as shown in FIG. 1A, each recess 103 may have a single polarizing feature (e.g., polarizing slot 108) per recess 103, with the polarizing slot 108 being in the same location for each recess 103. In other embodiments, each recess may have more than one polarizing feature and/or the polarizing feature may have different locations for different recesses. For example, the position of the polarizing features (e.g., polarizing slots 108) may have alternating locations at consecutive positions along the face of the connector.

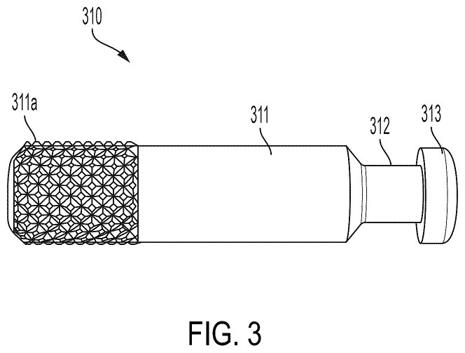

The plug connector 100 includes at least one securing structure 112 for securing the plug connector 100 to a receptacle connector. In this example, the plug connector 100 includes four securing structures 112 located on the side of the housing 102, two located towards the top of the plug connector 100 on opposite sides, and two located towards the bottom of the plug connector 100 on opposite sides. The securing structures are symmetrically disposed about two perpendicular centerlines of the mating face 102s (depicted by dotted lines in FIG. 1A). In this example, the securing structures 112 are pins securely attached to the housing and having head portions of larger diameter than the pins. In some embodiments, the pins may be knurled pins, such as is shown in FIG. 3. As shown in FIG. 3, the knurled pin 310 has a shaft 311, a neck 312, a head 313, and knurled shaft portion 311a. The pins are positioned for the neck 312 to engage with corresponding slots of a rotating latch of a receptacle connector, as discussed further below and illustrated in subsequent figures. The heads 313 have a diameter larger than the width of the slot of the rotating latch, which keeps the pin secured in the slot. The optional knurled shaft portion is installed in the housing and resists movement of the pin relative to the housing.

Returning to a discussion of FIG. 1A, the plug contacts 104 may be individually electrically connected to the conductors of cables 110 that protrude from the proximal side of the housing 102 opposite the side of the mating interface. In some embodiments, the cables 110 have the same number and arrangement (e.g., 2×2 array) as that of the plug contacts 104. The cables may have an insulating sheath covering any suitable diameter or gauge of conductor. In some embodiments, the cables 110 may be single core type W cables.

The plug connector 100 may be made of any suitable materials. The housing 102 may be formed of electrically insulating material that is relatively rigid, such as molded plastic. The plug contacts 104 may be formed of any suitable conductive material, such as copper, for example. As mentioned above, the insulating caps 106 may be formed of a suitable insulating material. The term “insulating” in the context of the present application refers to an electrically insulating material.

FIG. 1B shows an exploded view of the plug connector 100 including the housing 102, plug contacts 104, insulating caps 106, retention clips 107, as well as cables 110 of the cable assembly. The retention clips 107 retain the plug contacts 104 in the housing 102.

FIG. 1C shows a cutaway view of the housing 102 along the line 1C of FIG. 1A. FIG. 1C shows the interior of the housing has retention portions 117 on the sides of the recesses 103. The retention portions 117 are configured to engage with the retention clips 107 to retain the plug contacts 104 in the housing 102. The retention portions 117 may be tubular ridges of slightly larger diameter than a proximal portion of the recess 103, that provide spaces for the retention clips 107.

FIG. 1D shows a perspective view of a plug contact 104, according to some embodiments. Plug contact 104 includes a contact portion 104a for making contact with a complementary receptacle connector, a head portion 104b that can be attached to an insulating cap 106, and a neck portion 104c between the head portion 104b and the contact portion 104a. An insulating cap 106 may be snapped onto the head portion 104b.

FIG. 1E shows a front view of an insulating cap 106. As shown, insulating cap 106 may have openings therein.

FIG. 1F shows a rear perspective view of the insulating cap 106, showing the insulating cap has a plurality of tabs 106a configured to fit over the head portion 104b to retain the insulating cap 106 on the plug contact 104.

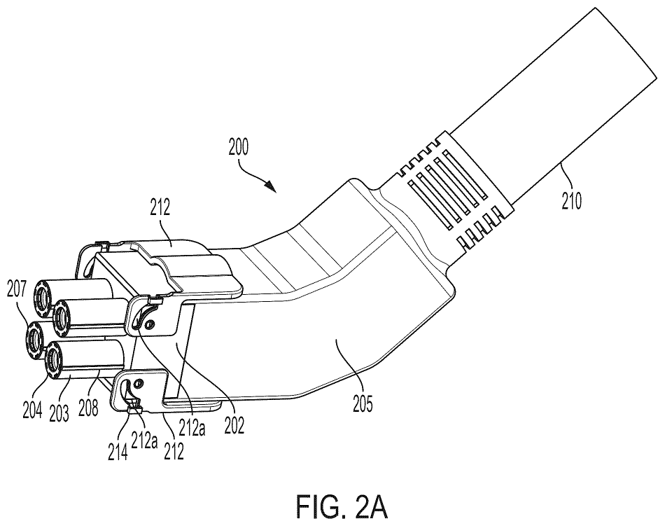

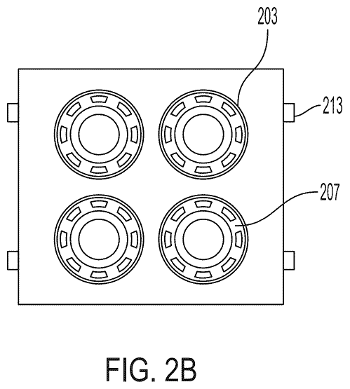

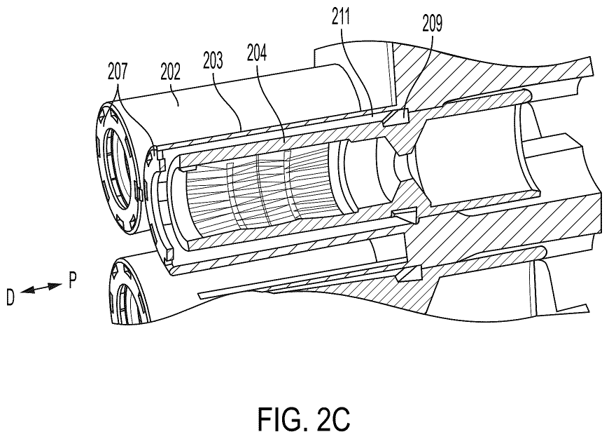

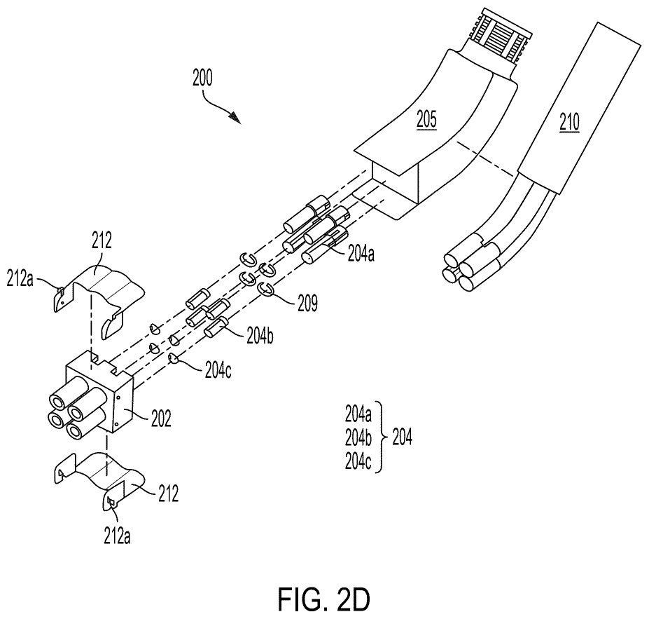

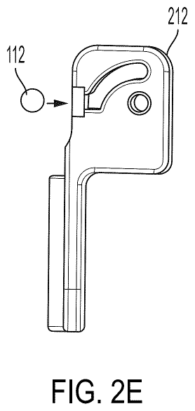

FIG. 2A shows an example of a receptacle connector 200 configured to mate with plug connector 100, according to some embodiments. Receptacle connector 200 and cable bundle 210 collectively form a cable assembly.

The receptacle connector 200 includes a housing 202 and over mold 205. The housing 202 includes a number of tubular protrusions 203. In this example, the housing 102 has four tubular protrusions 203 arranged in a 2 by 2 array. However, this is an example, and a receptacle connector may have any number of tubular protrusions 203 and receptacle contacts 204, such as fewer than four (e.g., two or three), or more than four (e.g., five, six, seven, eight or more), and the number and spacing of the tubular protrusions 203 of may correspond to the number and spacing of plug contacts on a complementary plug connector. The tubular protrusions 203 are insulating portions of the housing 202 that house respective receptacle contacts 204 (FIG. 2C) for making contact with the plug contacts 104 of a plug connector 100 when the plug connector 100 is connected to the receptacle connector 200. Each of the tubular protrusions 203 has an inner cylindrical space housing a receptacle contact 204. Receptacle contact 204 may be located at the inner surface of a tubular protrusion 203. The receptacle contact 204 may have a generally cylindrical shape. Receptacle contact 204 may be configured to press inward onto the plug contact 104 when the plug contact 104 is inserted into a tubular protrusion 203, which may provide for a robust electrical connection.

FIG. 2A also shows the receptacle connector 200 has at least one securing structure 212 for securing the receptacle connector 200 to the plug connector 100. In this example, the receptacle connector 200 includes two securing structures 212 located on the top and bottom of the housing 202, respectively. The location of the securing structures 212 may correspond to the location of the securing structures 112. The securing structures 212 are shown as rotating latches that are configured to rotate to receive securing structures 112 (e.g., pins) within respective slots 212a of the rotating latch, thereby securing receptacle connector 200 to plug connector 100. In the example of FIG. 2A, slot 212a has an enlarged opening 214 through which the head of a pin serving as a securing structure 112 may pass. Once passing through the enlarged opening 214, a neck of the pin may be in the slot 212a with the head of the pin outside the slot outside the outer surface of securing structure 212.

In use, the rotating latches may be rotated toward the distal direction toward the mating direction to be in the “open” position, causing the enlarged openings 214 of slots 212a of the rotating latches to face toward the distal direction and the securing structures 112. The securing structures 112 may be slid into the slot 212a, as depicted in the side-view of FIG. 2E for the bottom latch of FIG. 2A. The rotating latch may be rotated back into the “closed” position (shown in FIG. 2A for both latches) to secure the receptacle connector 200 to the plug connector 100. The slot is shaped such that rotation of the latch from the open to the closed position pulls receptacle connector 200 and a mating connector together.

Such rotation may be achieved in the example illustrated by pressing a proximal end of securing structure 212. Such a pressing motion may cause the securing structure 212 to rotate about hubs 213 (FIG. 2B). Hubs 213, in some examples, may be molded as part of the connector housing. In other examples, hubs 213 may be the ends pins inserted into the housing, including pins with knurled shafts. The pins may have heads, in some examples, to aid in rotatably holding securing structures 212 to the housing.

Rotating latches may provide a robust mechanical connection, while being simple to operate. In the example of FIG. 2A securing structures 212 are located on opposite sides of the connector housing and rotation of both securing structures into the locked position may be achieved by pressing the ends of the securing structures 212 toward the housing. In some examples, pressing both securing structures 212 towards the housing may be simply performed by a user with one hand and the motion required to latch both securing structures 212 may be performed by a user grasping the over mold 205, such as a person might grasp a handle.

In some embodiments, the securing structures 212 (e.g., rotating latches) may be formed of a metal to provide a robust mechanical connection. Any suitable metal may be used for the rotating latches, one example of which is aluminum, such as die cast or molded aluminum.

Optionally, securing structures 212 formed of a metal may be covered (e.g., coated) with an electrical insulating material, such as a silicone coating or over mold, for example. Rotating latches are described and illustrated as an example of a securing structure, and other types of securing structures may be used.

The tubular protrusions 203 may include one or more polarizing features, such as polarizing projections or slots. In this example, the polarizing features are polarizing projections 208 designed to be inserted into corresponding polarizing slots 108 of the recesses 103 of plug connector 100. As illustrated, the polarizing projections 208 may protrude from an exterior surface of an polarizing projection 208, and may extend in a plugging and unplugging direction. When the receptacle connector 200 is mated with a plug connector 100, corresponding polarizing projections 208 may extend into the polarizing slots 108.

In some embodiments, and as shown in FIG. 2A, each tubular protrusion 203 may have a single polarizing feature (e.g., polarizing projection 208) per tubular protrusions 203, with the polarizing feature being in the same location for each tubular protrusion 203. In other embodiments, each tubular protrusion 203 may have more than one polarizing feature and/or the polarizing features may have different locations for different tubular protrusions. For example, the position of the polarizing projections 208 may have alternating locations for consecutive positions along a face of the receptacle connector 200.

FIG. 2B shows a front view of the housing 202 including contact retention ring 207 at the distal end of each tubular protrusion 203 on the mating side of the housing 202. The contact retention rings 207 increase safety, as they prevent or reduce the likelihood of a person contacting the receptacle contacts 204 within the tubular protrusions 203. Accordingly, the receptacle connector 200 may be a touch proof connector. Herein, touch proof may indicate compliance with IEC 62368.

The inventors have also recognized and appreciated challenges that arise due to the increased currents and/or voltages used in data centers and similar installations. As power needs increase, the voltage levels provided through a cable assembly to a rack have increased. Voltage levels in the cables, and in connectors terminated to them, now may be in the range of hundreds of volts, which exceeds safety limits for human contact. Additionally, because more than one cable may provide power from the same source or to the same location, such as the same power shelf in a data center rack, a connector designed to mate with such a cable assembly may be energized even when the cable assembly intended to carry power to that connector is disconnected. As such mating connectors are conventionally not expected to be energized when the cable assembly is disconnected, the use of a conventional connector for mating to a cable assembly may pose a safety risk.

Further, as higher levels of electric current are needed, the contacts may be larger in cross-section to accommodate the increased current while keeping the series resistance and corresponding heat dissipation low. Contacts with an increased size (e.g., diameter), even if positioned in an opening of a connector housing, may be easier for a person to touch inadvertently because the openings of the housing may be larger. For example, if a receptacle connector is increased in size there is an increased opening size and greater opportunity for a person to touch an electrical contact within the receptacle connector. Connector designs as described herein may enhance safety by reducing the likelihood of a person inadvertently touching the contacts in both connectors of a set of mating connectors, even when the connectors are unmated.

FIG. 2C shows a cutaway cross-sectional view illustrating a receptacle contact 204 within a tubular protrusion 203, with the retention ring 207 located at a distal end of the tubular protrusion 203, extending inward at an inner surface of the tubular protrusion. The contact retention ring 207 may be snapped onto, pressed onto, or otherwise attached to the housing 202. In other examples, the contact retention ring 207 may be an integral part of the tubular protrusion 203. FIG. 2C also shows a retainer clip 209 for retaining the receptacle contact 204 within the tubular protrusion 203. As shown, the retainer clip may have a chamfered front surface that allows sliding the retainer clip 209 and receptacle contact 204 until the retainer clip 209 presses into an opening or slot 211 on the inner side of the tubular protrusion 203, thereby retaining the receptacle contact 204 in place within the tubular protrusion 203.

FIG. 2D shows an exploded view of the receptacle connector 200. As shown, the receptacle contacts 204 include tubular receptacle contacts 204a, contact bands 204b, and contact barrier rings 204c. The tubular receptacle contacts 204a provide mechanical support as well as significant current-carrying cross-sectional area. The tubular receptacle contacts 204a may have any suitable outer diameter, such as 15 mm to 25 mm, such as 17 mm to 22 mm (e.g., 19.5 mm). The contact bands 204b may be strips (e.g., of metal) that bow or otherwise protrude in an inward direction. When the plug contact 104 is inserted into tubular protrusion 203, the plug contact 104 presses against the plug contact 104 in an outward direction, causing the receptacle contact 204 to compress from its initial bowed or otherwise inward protruding position. The receptacle contact 204 exerts an inward force on the plug contact 104 by the spring-like action of the receptacle contact 204, which provides a strong electrical and mechanical connection. In other embodiments, the receptacle contact 204 may take the form of tabs or other protrusions that press against the plug contact 104.

FIG. 2D shows an over mold 205 that is shaped for a 45° cable exit for cable bundle 210. However, the outer mold may be shaped for any angle of cable exit, such as 0° or 90° or any angle in between, for example. The receptacle contacts 204 may be individually electrically connected to respective conductors of the cable bundle 210. In some embodiments, cable bundle 210 may be a 3/0 AWG 4 core Type W cable.

The receptacle connector 200 may be made of any suitable materials. The housing 202 may be formed of electrically insulating material that is relatively rigid, such as molded plastic. The receptacle contacts 204 may be formed of any suitable conductive material, such as copper, for example.

Having thus described several aspects of at least one embodiment of this invention, it is to be appreciated that various alterations, modifications, and improvements will readily occur to those skilled in the art. Such alterations, modifications, and improvements are intended to be within the spirit and scope of the invention. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value. For example, a phrase “between 10 and 20” is intended to mean “between exactly 10 and exactly 20” in some embodiments, as well as “between 10±d1 and 20±d2” in some embodiments. The amount of variation d1, d2 for a value may be less than 5% of the value in some embodiments, less than 10% of the value in some embodiments, and yet less than 20% of the value in some embodiments. When only exact values are intended, the term “exactly” is used, e.g., “between exactly 2 and exactly 200.” Similarly, when a value, such as a dimension is recited without the term “exactly” the value may vary by 5%, 10% or up to 20% in various embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A plug connector, comprising:
a housing having recesses, wherein the recesses are arranged in rows;
plug contacts within the recesses; and
securing structures configured to attach the plug connector to a receptacle connector.

2. The plug connector of claim 1, wherein the recesses are arranged in exactly two rows.

3. The plug connector of claim 2, wherein the recesses are arranged in a 2×2 array.

4. The plug connector of claim 1, wherein the securing structures comprise pins configured to engage with slots of a rotating latch of a receptacle connector.

5. The plug connector of claim 4, wherein the securing structures comprise four pins configured to engage with rotating latches of a receptacle connector.

6. The plug connector of claim 1, wherein the securing structures are configured to engage with a plurality of rotating latches of a receptacle connector.

7. The plug connector of claim 6, wherein:
the housing comprises two opposing sides and a mating face therebetween;
the recesses are exposed at the mating face;
the securing structures include two securing structures on each of the two opposing sides; and
the securing structures are symmetrically disposed about two perpendicular centerlines of the mating face.

8. The plug connector of claim 7, wherein the securing structures comprise exposed ends of pins inserted into the housing.

9. The plug connector of claim 8, wherein the pins each comprise a neck and a head extending from the housing.

10. The plug connector of claim 8, wherein the pins comprise knurled portions inserted into the housing.

11.-16. (canceled)

17. A receptacle connector, comprising:
a housing having tubular protrusions, the tubular protrusions having receptacle contacts at inner sides of the tubular protrusions, the tubular protrusions extending along a plugging and unplugging direction of the receptacle connector, wherein the tubular protrusions are arranged in rows; and
securing structures configured to attach the receptacle connector to a plug connector.

18. The receptacle connector of claim 17, wherein the tubular protrusions are arranged in exactly two rows.

19. The receptacle connector of claim 18, wherein the tubular protrusions are arranged in a 2×2 array.

20. The receptacle connector of claim 17, wherein an outer diameter of the receptacle contacts is between 17 mm and 22 mm.

21. The receptacle connector of claim 17, wherein the securing structures comprises rotating latches.

22. The receptacle connector of claim 17, wherein the securing structures comprises a first rotating latch on a first side of the housing and a second rotating latch on a second side of the housing opposite the first side.

23. The receptacle connector of claim 22, further comprising an over mold attached to the housing.

24. The receptacle connector of claim 23, wherein, when the over mold acts as a gripping surface.

25. The receptacle connector of claim 23, wherein the first and second rotating latches have respective slots configured such that when the first and second rotating latches are in an open position rotated away from the over mold the slots are positioned to receive respective pins of a mating connector.

26. The receptacle connector of claim 25, wherein the slots are configured such that closing the first and second rotating latches by rotating the first and second rotating latches toward the over mold pulls the receptacle connector towards a mating connector.

27. The receptacle connector of claim 26, wherein the rotating latches comprise a metal.

28. The receptacle connector of claim 27, wherein the metal is covered with an insulating material.

29.-38. (canceled)

39. A cable assembly, comprising:
a receptacle connector, including:
a housing having tubular protrusions, the tubular protrusions having receptacle contacts at inner sides of the tubular protrusions, the tubular protrusions extending along a plugging and unplugging direction of the receptacle connector, wherein the tubular protrusions are arranged in rows; and
securing structures configured to attach the receptacle connector to a plug connector; and
a cable bundle having conductors electrically coupled to the receptacle contacts.

40. The cable assembly of claim 39, wherein the securing structures comprises rotating latches.

41. The cable assembly of claim 40, wherein the securing structures comprises a first rotating latch on a first side of the housing and a second rotating latch on a second side of the housing opposite the first side.

42. The cable assembly of claim 41, further comprising an over mold attached to the housing.

43. The cable assembly of claim 42, wherein, when the over mold acts as a gripping surface.

44. The cable assembly of claim 42, wherein the first and second rotating latches have respective slots configured such that when the first and second latches are in an open position rotated away from the over mold the slots are positioned to receive respective pins of a mating connector.

45. The cable assembly of claim 44, wherein the slots are configured such that closing the first and second latches by rotating the first and second latches toward the over mold pulls the receptacle connector towards a mating connector.
